(19) United States
(12) Patent Application Publication
(10) Pub. No.: US 2015/0132136 A1
(43) Pub. Date: May 14, 2015

(54) ROTOR HAVING A BASIC ROTOR BODY AND A PLURALITY OF ROTATING BLADES MOUNTED THEREON

(71) Applicant: MTU Aero Engines AG, Munich (DE)

(72) Inventors: Manfred Feldmann, Eichenau (DE); Thomas Hess, Munchen (DE)

(21) Appl. No.: 14/506,247

(22) Filed: Oct. 3, 2014

(30) Foreign Application Priority Data
Oct. 10, 2013 (DE) 102013220467.1

(51) Int. Cl. F01D 5/30

(52) U.S. Cl. CPC F01D 5/30; F05D 2230/60
USPC 416/204 R; 29/888.012

(57) ABSTRACT

A rotor (10) has a basic rotor body (12) and a plurality of rotating blades (14) mounted on the basic rotor body (12). The rotating blades (14) in this case are mounted rigidly or non-detachably, in particular, cohesively, on the basic rotor body (12). Thus, at least one rotating blade (14) has at least one integral sealing element (24), by means of which a root intermediate space (22) is sealed in the region of a blade root (20) radially underneath a blade platform (18) of the rotating blade (14). In addition, the invention relates to a method for producing a rotor (10), in particular, for an aircraft engine, in which a plurality of rotating blades (14) is mounted on a basic rotor body (12), wherein at least one rotating blade (14) having at least one integral sealing element (24) is mounted on the basic rotor body (12).

The invention relates to a rotor having a basic rotor body and a plurality of rotating blades mounted on the basic rotor body. In addition, the invention relates to a method for producing this type of rotor, a rotating blade for such a rotor, as well as an aircraft engine.

Traditionally, rotors for thermal gas turbines comprise rotating blades that are detachably mounted to a basic rotor body. For this, for example, a dovetail-shaped piece of the rotating blade is fitted into a complementary formed slot in the basic rotor body extending in the axial direction of the gas turbine and subsequently secured against slipping out in the axial direction. For various reasons, in particular, for reasons of weight, however, rotors for thermal gas turbines in which the rotating blades are mounted rigidly or non-detachably, in particular, cohesively, to the basic rotor body have recently been used increasingly more often. Such rotors, for example, turbine rotors, are designated depending on the structural form thereof as “blisk” or “bling”, wherein these combined synthesized words are made up of “blade” and “disk” or “blade” and “ring”. The present invention in this case relates to the last-named type of rotors, i.e., rotors for which the rotating blades are mounted rigidly or non-detachably, in particular, cohesively, to the basic rotor body.

Due to the large differences in temperature that occur during operation in an engine between those regions of the rotor that are disposed in a hot-gas channel of the gas turbine and the regions of the rotor that are shielded from the hot gas, especially high temperature gradients result, in particular, in the transition zone near the radially inner boundary of the hot-gas channel, i.e., in the region of blade platforms of the rotating blades. In order not to induce stresses in the rotor that are too high due to thermal expansions resulting from these temperature differences, the blades must therefore be separated from one another also underneath their blade platform by corresponding notches down to a region in which the temperatures that are to be expected during operation have fallen to an acceptable level.

By means of these notches, intermediate spaces are formed between the roots, these spaces extending in the radial direction between the undersides of the respective blade platforms and the basic rotor body, and forming leakage cross sections, which must be sealed again correspondingly, in order to prevent or at least to minimize an undesired leakage flow in the axial direction of the corresponding turbomachine. It is known, for example, to dispose individual stoppers that are adapted to the geometry of the individual notches into the root intermediate spaces in order to seal off these intermediate spaces. For this purpose, however, many components are correspondingly necessary, which must be fabricated with high precision. This leads to comparatively high production and assembly costs. Moreover, these stoppers may damage the basic rotor body and the rotating blades in some cases due to micromovements occurring during the operation of the associated turbine.

Alternatively, it is also known to use segment-shaped sealing plates for the seal, the plates being mounted in corresponding uptakes on one side of the basic rotor body and being borne by the latter. In order to obtain the necessary form fit between basic rotor body and sealing plate, the sealing plate or an additional closure part is additionally deformed after mounting on the basic rotor body. This solution also leads to comparatively high production and assembly costs, since many components are also required, which, in addition, must be very precisely fabricated.

Finally, it is known to mount a single sealing ring on one side of the basic rotor body. Since such sealing rings, however, are subjected to high centrifugal-force loads during operation, raw materials and fabricated sealing-ring products must be adapted to the high loads, which also brings about comparatively high costs in the case of this component.

An object of the present invention is to provide a bladed rotor, which has an improved sealing of the root intermediate spaces between the blade platforms of its rotating blades and its basic rotor body. Additional objects of the invention consist in providing a method for producing such a rotor, a rotating blade for such a rotor, as well as an aircraft engine having such a rotor.

The objects are achieved according to the invention by a rotor with the features of patent claim 1, a method with the features of patent claim 9, a rotating blade with the features of patent claim 12, and an aircraft engine according to patent claim 14. Advantageous embodiments with appropriate enhancements of the invention are indicated in the respective dependent claims.

A first aspect of the invention relates to a rotor, which is suitable, in particular, for an aircraft engine, and comprises a basic rotor body as well as a plurality of rotating blades mounted on the basic rotor body. The rotating blades in this case are mounted rigidly or non-detachably, in particular, cohesively, on the basic rotor body. An improved sealing of the root intermediate spaces between the blade platforms of the rotating blades thereof and the basic rotor body thereof in this case is achieved according to the invention in that at least one rotating blade has at least one integral sealing element, by means of which a root intermediate space is sealed in the region of a blade root radially underneath a blade platform of the rotating blade, in particular in the axial direction of the corresponding turbomachine. In other words, it is provided according to the invention that one, several, or all of the rotating blades fastened to the basic rotor body in each case have an integrated sealing element for sealing an associated root intermediate space. In this way, in addition to an improved sealing based on smaller leakage cross sections, an advantageous reduction in weight, as well as a simplified and cost-effective production of the rotor are also made possible The sealing element or elements can be designed, for example, as integral separating walls projecting from the blade root and thus can function as a type of partition or partition wall.

A particularly reliable seal is obtained in another embodiment of the invention, in that the at least one sealing element extends in the direction of a vertical axis of the respective rotating blade, proceeding from a blade platform along the blade root of the respective rotating blade, at least down to the bottom of the blade root. In other words, the sealing element has or the elements have the same height, at least essentially, as the blade root disposed also radially underneath the blade platform, relative to an axis of rotation of the rotor. Likewise, it may be provided that some or all sealing elements project out in the radial direction beyond the bottom of the blade root, i.e., they have a greater height then the blade root. In this case, for example, a radial groove running in the peripheral direction can be provided in the basic rotor body, and a corresponding section of the sealing element can project into this groove.

Additional advantages result by arranging the at least one sealing element, relative to an axis of rotation of the rotor, in the region of a front side and/or in the region of a back side of the rotating blade and/or in the peripheral direction on one side of the blade root and/or on both sides of the blade root. In other words, it is provided according to the invention that some or all rotating blades have at least one sealing element in the region of their front side lying upstream, considered in the direction of flow, and/or in the region of their back side lying downstream. Alternatively or additionally, the sealing element can be formed only on one side of the blade root, when considered in the peripheral direction or direction of rotation. Alternatively, the sealing element can be formed on both sides of the blade root, whereby for this purpose, basically, a continuous sealing element or two individual sealing elements can be used in order to seal a respective root intermediate space. In this way, the required sealing effect and air conduction can be optimally adjusted in each case.

In another advantageous embodiment of the invention, at least one sealing element overlaps once and/or several times with a sealing element that is adjacent to it in each case and/or with the basic body. In other words, it is provided according to the invention that the sealing elements overlap in a type of tongue-and-groove joint or in a kind of tongue-and-groove manner with a sealing element that is adjacent to it in each case or with the basic body. In this way, the rotor can be constructed with a minimum of possible gaps, whereby, in an advantageous way and at the same time, seals are formed with sliding seats that make possible an equilibration of expansion.

Additional advantages result if the at least one sealing element is engaged in a groove and/or a step in the basic rotor body. In this way, in addition to an improved sealing, a higher mechanical stability as well as a better damping of vibrations of the rotor are also achieved.

In another advantageous embodiment of the invention, the groove and/or the step runs in the peripheral direction of the basic rotor body. In other words, in the connection region of the rotating blades, the basic rotor body comprises at least one groove running around the outer periphery or a step running around the outer periphery, in which the sealing element or elements of the associated rotating blades are disposed. In this way, a particularly good sealing as well as a particularly high mechanical stability are assured.

An additional improvement of the vibration properties of the rotor is achieved in another embodiment of the invention, in that at least two adjacent rotating blades are present in each case as blade clusters, wherein at least two adjacent rotating blades of the blade cluster are joined together via an outer shroud.

In another advantageous embodiment of the invention, it is provided that the basic rotor body is composed of a wrought alloy and/or in that the rotating blades are composed of a high temperature-resistant alloy and/or are produced generatively. In this way, a particularly high tolerance of the rotor relative to temperature gradients as well as a particularly cost-effective and flexible production of the rotor are made possible.

A second aspect of the invention relates to a method for producing a rotor, in particular for an aircraft engine, in which a plurality of rotating blades is mounted rigidly or non-detachably on a basic rotor body, in particular, cohesively. “To mount” in the sense of the present invention is also understood as a construction or building up of the rotating blades on the basic rotor body by a generative method, in particular, a building up of the rotating blades by a loose, granular base material which is melted locally in a selective manner, for example, by means of a laser, and is thus solidified, in order to endow the rotating blade with its corresponding shape. It is thus provided according to the invention that at least one rotating blade having at least one integral sealing element is mounted on the basic rotor body, whereby a respective root intermediate space is sealed in the region of a blade root radially underneath a blade platform of the respective rotating blade by means of the at least one sealing element, in particular, is sealed in the axial direction of the corresponding turbomachine. In this way, in addition to an improved seal based on smaller leakage cross sections, an advantageous reduction in weight as well as a simplified and cost-effective production of the rotor are also made possible The sealing element or elements can be designed, for example, as integral separating wall(s) and thus can function as a type of partition or partition wall. Additional features and the advantages thereof can be derived from the descriptions of the first aspect of the invention, wherein advantageous embodiments of the first aspect of the invention are to be viewed as advantageous embodiments of the second aspect of the invention, and vice versa.

In an advantageous embodiment of the invention, the basic rotor body is produced by turning as a rotor disk. In other words, it is provided that the basic rotor body is produced by machining from a semi-finished product in the form of a rotor disk. This is then used as a base for mounting the rotating blades. The basic rotor body can be fabricated, for example, from a wrought material.

In another advantageous embodiment of the invention, it is provided that first, the basic rotor body is provided, and the rotating blades together with their integral sealing elements are built up generatively on the basic rotor body. This makes possible a particularly flexible production of the rotor, since the geometrically less demanding basic rotor body can be produced conventionally or not generatively, and can be provided with various rotating blades, depending on the later application purpose of the rotor. For rotating blades that are directly constructed on the basic rotor body, the various advantages of generative manufacturing methods can then be realized. In particular, in the case of generative manufacturing methods, the economics increase with increasing complexity of the component geometry. Moreover, due to the generative construction of the rotating blades on the basic rotor body, additional joining steps, such as welding or soldering, for example, which are otherwise necessary, can be dispensed with. Further, by building up the rotating blades on the basic rotor body by means of generative methods, the sealing effect can be further increased, if the integral sealing element engages in a radial groove provided in the basic rotor body and extending in the peripheral direction, at least in sections, this groove being able to have been introduced in the basic rotor body in a cost-effective manner beforehand, for example, by a turning process. This cannot be achieved with the more common friction welding process for the fastening of rotating blades on the basic rotor body, or can only be achieved with incomparably high expense, since in the case of friction welding, it is usually necessary to move the rotating blades to be fastened in complex movement patterns relative to the basic rotor body.

A third aspect of the invention relates to a rotating blade for arrangement on a basic body of a rotor. In this case, it is provided according to the invention that the rotating blade has at least one integral sealing element, by means of which a root intermediate space in the region of a blade root can be sealed radially underneath a blade platform of the rotating blade in the rigid or non-detachable, in particular, cohesively mounted state of the rotating blade. An advantageous reduction in weight as well as a simplified and cost-effective production of a rotor are also made possible in this way, in addition to an improved sealing due to smaller leakage cross sections. The sealing element can extend, for example, in the form of a wall, in the direction of a vertical axis of the rotating blade, proceeding from its blade platform along the blade root, at least down to the basic rotor body. Additional features and the advantages thereof can be derived from the descriptions of the first and second aspects of the invention, wherein advantageous embodiments of the first and second aspects of the invention are to be viewed as advantageous embodiments of the third aspect of the invention, and vice versa.

A particularly good sealing effect is made possible in an advantageous embodiment of the invention, in that the integral sealing element embraces the blade root in a U-shaped manner. In this way, in the mounted state of the rotating blade, a peripheral sealing effect with minimal gaps is ensured in the region radially underneath the blade platform.

A fourth aspect of the invention relates to an aircraft engine having a rotor that is designed according to an embodiment of the first aspect of the invention and/or is produced by means of a method according to the second aspect of the invention and/or comprises at least one rotating blade according to an embodiment of the third aspect of the invention. The features resulting therefrom and the advantages thereof can be taken from the descriptions of the preceding aspects of the invention.

Further features of the invention result from the claims, the embodiment examples, as well as on the basis of the drawings. The features and combinations of features named in the preceding description, as well as the features and combinations of features named in the examples of embodiment below can be used not only in the combination indicated in each case, but also in other combinations, without departing from the scope of the invention. Herein:

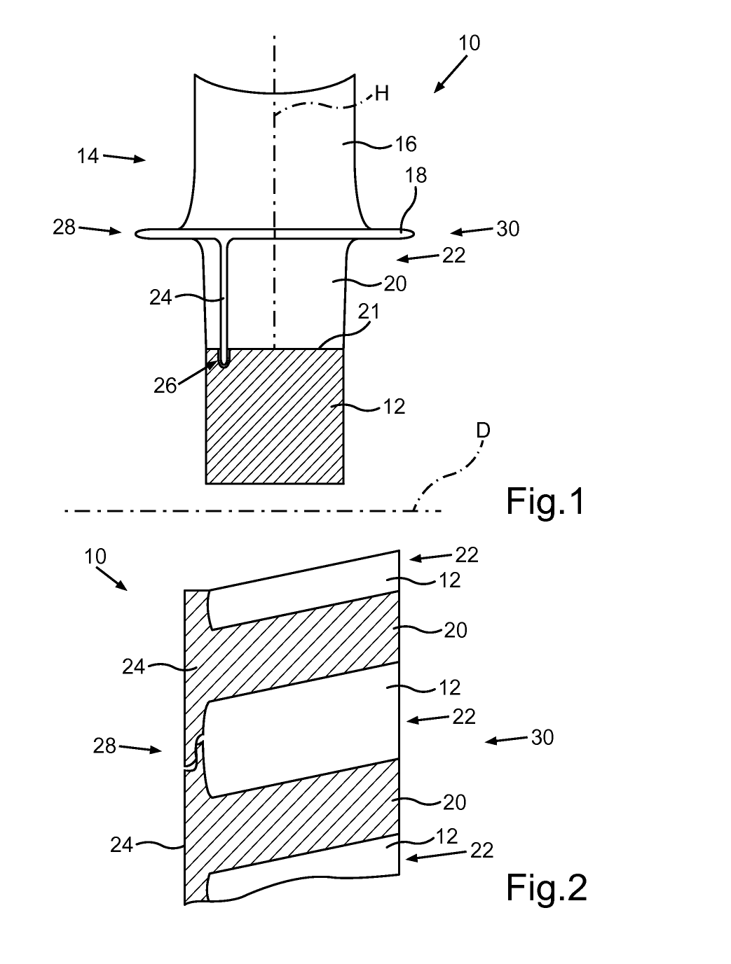

FIG. 1 shows a partially cut-away, schematic perspective illustration of a rotor according to the invention according to a first embodiment; and

FIG. 2 shows a partially cut-away top view of the rotor according to the invention according to a second embodiment.

FIG. 1 shows a partially cut-away, schematic perspective illustration (meridian section) of a rotor 10 according to the invention according to a first embodiment. The rotor 10, which is presently designed as a turbine blisk for an aircraft engine, comprises a cut-away basic rotor body 12 as illustrated, on which several rotating blades 14 are mounted. Each rotating blade 14 comprises in this case at least one blade part 16 and a blade platform 18 lying radially thereunder relative to an axis of rotation D of the rotor. The blade platform 18 represents a radially inner boundary of a hot-gas channel and will prevent hot gas from the hot-gas channel from reaching into the cooler region underneath the blade platform 18. For the radially outer boundary of the hot-gas channel, it can be provided that the rotating blades 14 have a radially outer shroud (not shown). Radially underneath the blade platform 18 is found a blade root 20 of the rotating blade 14, by means of which the rotating blade 14 is joined with the basic rotor body 12.

Radial temperature gradients that are too great occur during the operation of the rotor 10. Thus, in order not to induce stresses in the rotor 10 that are too high due to thermal expansions resulting from these temperature differences, the rotating blades 14 are also separated from one another underneath their blade platforms 18 by way of corresponding notches down to the basic rotor body 12. Due to these notches, leakage cross sections result in the root intermediate spaces 22 that are formed, these spaces extending in the radial direction between the undersides of the respective blade platforms 18 and the basic rotor body 12; these leakage cross sections must be sealed again correspondingly, in order to prevent or at least to minimize an undesired leakage flow, particularly in the axial direction of the aircraft engine. In order to seal the root intermediate spaces, the rotating blades 14 each comprise an integral sealing element 24, by means of which associated root intermediate spaces 22 are sealed in the region radially underneath the blade platforms 18 and along the blade roots 20 of the individual rotating blades 14.

As can be recognized in FIG. 1, the sealing element 24 functioning as a partition wall extends in the direction of a vertical axis H of the rotating blade 14 concerned, proceeding from the blade platform 18 along the blade root 20 of the rotating blade 14 beyond the bottom 21 of the blade root 20 and projecting in this case into a groove 26, which runs in the peripheral direction, of the basic rotor body 12. Single, as well as double, triple, etc. overlappings between the underside of the sealing element 24 and the basic rotor body 12 are conceivable here. In addition, it can be provided that the sealing element 24 embraces the blade root 20 in a U-shaped manner. An integral seal with a minimum of possible gaps and without the necessity of additional components is obtained in this way. Due to the wall-shaped embodiment of the sealing element 24 and the groove running in the peripheral direction, a sliding seat is also formed, which makes possible a particularly good expansion equilibration. The sealing element 24 can be provided for in the region of a front side 28, as shown in FIG. 1, and/or in the region of a back side 30, depending on the given requirements. The rotating blades 14 can be constructed, moreover, also as a two-blade cluster, which additionally can be joined together on the shroud, in order to assure a particularly high damping of vibrations.

The rotating blades 14 together with their integrated sealing elements 24 are thus built up generatively on a rotated basic rotor body 12, which is composed of a wrought alloy. A suitable material, for example, a high temperature-resistant alloy is used for the rotating blades 14. It can also be provided that the rotating blades 14 are fabricated of different materials. The material or materials used for the rotating blades 14 can be different from the material used for the basic rotor body 12.

FIG. 2 shows a partially cut-away top view of the rotor 10 according to the invention according to a second embodiment. It is recognized that, unlike the case in the first example of embodiment, the sealing elements 24 terminate flush with the basic rotor body 12 on the front side 28. For this purpose, the sealing elements 24 are disposed in a corresponding step (not shown) running in the peripheral direction in the basic rotor body 12. In addition, it can be recognized that the sealing elements 24 extend continuously to both sides of the respective blade roots 20. The side walls of the sealing elements 24 in this case overlap with adjacent sealing elements 24 in a type of tongue and groove, whereby also a sliding seat is formed, which makes possible a particularly good expansion equilibration. In addition to the single overlapping that is shown, of course, double, triple, etc. overlapping is also conceivable for this case.

1. A rotor (10) for an aircraft engine, comprising a basic rotor body (12) and a plurality of rotating blades (14) mounted on the basic rotor body (12), wherein the rotating blades (14) are mounted rigidly or non-detachably cohesively on the basic rotor body (12), wherein at least one rotating blade (14) has at least one integral sealing element (24), wherein a root intermediate space (22) is sealed in the region of a blade root (20) radially underneath a blade platform (18) of the rotating blade (14).

2. The rotor (10) according to claim 1, wherein the at least one sealing element (24) extends in the direction of a vertical axis (H) of the respective rotating blade (14), proceeding from a blade platform (18) along the blade root (20) of the respective rotating blade (14), at least down to a bottom (21) of the blade root (20).

3. The rotor (10) according to claim 1, wherein, relative to an axis of rotation (D) of the rotor (10), the at least one integral sealing element (24) is disposed in the region of a front side (28) and/or in the region of a back side (30) of the rotating blade (14) and/or in the peripheral direction on one side of the blade root (20) and/or on both sides of the blade root (20).

4. The rotor according to claim 1, wherein the at least one sealing element (24) is overlapped once and/or several times with a sealing element (24) adjacent to it each time and/or with the basic body (12).

5. The rotor (10) according to claim 1, wherein the at least one sealing element (24) engages in a groove (26) and/or a step in the basic rotor body (12).

6. The rotor (10) according to claim 5, wherein the groove (26) and/or the step runs in the peripheral direction of the basic rotor body (12).

7. The rotor (10) according to claim 1, wherein in each case, at least two adjacent rotating blades (14) are present as blade clusters, wherein at least two adjacent rotating blades (14) of the blade cluster are joined together via an outer shroud.

8. The rotor (10) according to claim 1, wherein the basic rotor body (12) is composed of a wrought alloy and/or in that the rotating blades (14) are composed of a high temperature-resistant alloy and/or are produced generatively.

9. A method for producing a rotor (10) for an aircraft engine, in which a plurality of rotating blades (14) is mounted rigidly or non-detachably cohesively on a basic rotor body (12), wherein at least one rotating blade (14) having at least one integral sealing element (24) is mounted on the basic rotor body (12), wherein, by means of the at least one sealing element (24), a respective root intermediate space (22) is sealed in the region of a blade root (20) radially underneath a blade platform (18) of the respective rotating blade (14).

10. The method according to claim 9, wherein the basic rotor body (12) is produced by turning or machining a rotor disk.

11. The method according to claim 9, wherein the basic rotor body (12) is provided first, and the rotating blades (14) together with their integral sealing elements (24) are built up generatively on the basic rotor body (12).

12. A rotating blade (14) for the arrangement on a basic rotor body (12) of a rotor (10), comprising at least one integral sealing element (24), wherein a root intermediate space (22) can be sealed in the region of a blade root (20) radially underneath a blade platform (18) of the rotating blade (14) in the rigid or non-detachable cohesively mounted state of the rotating blade (14).

13. The rotating blade (14) according to claim 12, wherein the integral sealing element (24) embraces the blade root (20) in U-shaped manner.

14. (canceled)

15. The rotor of claim 1, wherein the rotor is configured and arranged for use in an aircraft engine.

16. The method of claim 9, wherein the rotor is configured and arranged for use in an aircraft engine.

17. The rotating blade of claim 12, wherein the rotating blade is configured and arranged for use in an aircraft engine.
